(19) United States
(12) Patent Application Publication
(10) Pub. No.: US 2006/0118141 A1
(43) Pub. Date: Jun. 8, 2006

(54) Method of cleaning a washing machine or a dishwasher

(75) Inventors: Stefania Andriola, Brussel (BE); Marc Francois Theophile Evers, Strombeek-Bever (BE); Stefano Scialla, Rome (IT); Oreste Todini, Brussel (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/295,908

(22) Filed: Dec. 7, 2005

(30) Foreign Application Priority Data
Dec. 8, 2004 (EP) 04078337.5

(51) Int. Cl. B08B 7/00

(52) U.S. Cl. 134/42

(57) ABSTRACT

The present invention relates to a method of cleaning the interior surfaces of a non-loaded washing machine or a non-loaded automatic dishwasher with a particulate composition by forming in said washing machine or automatic dishwasher an acidic aqueous liquor comprising water and dissolved or dispersed therein said particulate composition, wherein said particulate composition comprises an effervescence system and sufficient acid to form an acidic aqueous liquor having a pH of below about 4.

### TECHNICAL FIELD

The present invention relates to a method of cleaning a non-loaded washing machine or automatic dishwasher. In particular, the present invention relates to a method of cleaning the inside (including dispensers, piping systems, drawers, etc.) of a non-loaded washing machine or automatic dishwasher by removing from the interior surfaces of the washing machine or automatic dishwasher limescale deposits as well as wash residues, grease, dirt, particulate residues, other soil residues and/or other encrustations.

### BACKGROUND OF THE INVENTION

The interior surfaces of laundry washing machines and automatic dishwashers (“washing appliances”) are prone to soiling upon use. In particular, limescale deposits are formed on the interior surfaces of laundry washing machines and automatic dishwashers due to the hardness of the tap water used to wash laundry or dishes in these washing appliances. Indeed, upon heating the tap water in washing appliances, the calcium and magnesium carbonate present in the tap water (water hardness) becomes less water soluble and is deposited as limescale deposits on the interior surfaces (such as heating elements, drums, rubber hoses, pipes, pumps, stainless steel surfaces of the washing compartment) of the appliances. Furthermore other deposits, such as wash residues, grease, dirt, particulate residues, other soil residues and/or other encrustations, can be formed on such interior surfaces. Over time, i.e., over a number of wash cycles, the limescale and other deposits on the interior surfaces of the appliances start to build up. This deposits-buildup can lead to severe damage of the washing machines and automatic dishwashers. Indeed, for example rubber surfaces, such as hoses, can become brittle and lead to leakage and heating elements lose their heating efficacy. Furthermore, some of the deposits can be the breading ground for fungi or bacteria, which leads to unhygienic contamination of the washing appliances resulting in odor and/or antimicrobial contamination of laundry or dishes.

In order to reduce the formation of limescale deposits in washing machines various products are on the market to be added with the laundry detergent for each washing cycle. Such products are for example marketed under the tradename Calgon®. Furthermore, in a number of automatic dishwashers a special salt compartment is present, which is filled with NaCl, in order to reduce the effect of water hardness. However, even though the formation of limescale deposits can be reduced using the above products, the formation of limescale deposits still occurs. Over time, this reduced limescale build-up can still lead to the above mentioned washing appliance damage. Moreover, there are a number of consumers that refrain from adding limescale deposits reducing products into the normal washing cycle of their washing machines and/or fail to comply with the requirement to add salt into the automatic dishwashers. In addition, the formation of deposits other than limescale in the washing appliances is not significantly reduced by the above products.

In view thereof, products have been developed that are used to clean the interior surfaces of washing appliances (laundry washing machines and automatic dishwashers) in a separate cycle without any laundry or dishes present in the appliance. Indeed, such products are used in a non-loaded cycle as they are not compatible with laundry or dishes. Various products and product forms (liquid, powder and tablets) of such washing appliances cleaners are currently marketed.

Particulate (such as powders, pearls, tablets, etc.) washing appliances cleaners are preferred by some consumers over liquid washing appliances as they are easier to dose and to introduce into the washing appliance.

Even though the currently available particulate washing appliances cleaners show some performance in removing limescale deposits as well as other deposits for the interior surfaces of laundry washing machines and automatic dishwashers, it has been found that the cleaning performance (i.e., the capability to remove limescale and/or other deposits) and/or the dissolution of such products can be still further improved. In particular, in view of the on-going trend to reduce the temperature and/or the cycle time at which such products are used, fast dissolution is an important feature of particulate washing appliances cleaners.

It is thus an objective of the present invention to provide a method of cleaning the interior surfaces of a washing machine or an automatic dishwasher using a particulate washing appliances cleaner, which delivers effective cleaning performance (i.e., the capability to remove limescale and/or other deposits) and/or effective dissolution of the appliance cleaner composition in the washing appliance.

It has now been found that the method according to the present invention meets the above objective.

### SUMMARY OF THE INVENTION

The present invention encompasses a method of cleaning the interior surfaces of a non-loaded washing machine or a non-loaded automatic dishwasher with a particulate composition by forming in said washing machine or automatic dishwasher an acidic aqueous liquor comprising water and dissolved or dispersed therein said particulate composition, wherein said particulate composition comprises an effervescence system and sufficient acid to form an acidic aqueous liquor having a pH of below 4.

### DETAILED DESCRIPTION OF THE INVENTION

### Method of Cleaning the Interior Surfaces of a Non-Loaded Washing Machine or a Non-Loaded Automatic Dishwasher

The present invention encompasses a method of cleaning the interior surfaces of a non-loaded washing machine or a non-loaded automatic dishwasher.

By “cleaning” it is meant herein fully or at least partially removing deposits such as limescale (“limescale deposits”), as well as “other deposits” such as: wash residues; soil residues, such as grease, dirt, particulate residues, and other soil residues; limescale-wash residues mixtures; limescale-soil mixture residues; wash residues-soil mixtures; limescale-wash residues-soil mixture; and/or other encrustations

By “interior surfaces of washing machines or automatic dishwashers” it is meant herein surfaces of washing machines or automatic dishwashers that come into contact with the wash liquor formed upon normal operation of such washing appliances. Such interior surfaces of washing machines or automatic dishwashers include: heating elements; rubber or metal hoses; drums; pumps and piping systems; stainless steel or ceramic surfaces forming the inside of the washing compartment; drawers, dispensers and dosing compartments; filters; dish and/or cutlery racks; and the like.

By “non-loaded” washing machines or automatic dishwashers it is meant herein, washing machines or automatic dishwashers that do not contain any items, such as laundry items or dishes/cutlery respectively, which are commonly cleaned, washed or treated in the washing machines or automatic dishwashers. However, the washing machines or automatic dishwashers contain water and dissolved or dispersed therein the particulate composition of the present invention as well as loose or removably attached items such as filters or racks, forming part of the washing machine or automatic dishwasher, and may also comprise dosing means for the particulate composition of the present invention, such as a dosing ball, a dosing sachet, and the like.

The method of cleaning the interior surfaces of a non-loaded washing machine or a non-loaded automatic dishwasher herein comprises the step of forming in said washing machine or automatic dishwasher an acidic aqueous liquor comprising water and dissolved or dispersed therein a particulate composition. A suitable means for forming in said washing machine or automatic dishwasher the acidic aqueous liquor is to operate a wash cycle of said washing machine or automatic dishwasher. Said wash cycle may be any wash cycle pre-programmed or programmable of said washing machine or automatic dishwasher, provided it involves the use of water. Indeed, said wash cycle may be a full wash cycle, including pre- and main-wash, or a main-wash cycle or a pre-wash cycle or a rinse cycle. Preferably, the wash cycle of said washing machine or automatic dishwasher is a short cycle such as a delicate laundry cycle for a washing machine or a pre-wash or economical/ecological cycle for an automatic dishwasher. In a preferred embodiment, the process herein additionally comprises a rinsing step, preferably after the cycle in which the particulate composition performs its action.

The method according to the present invention may be performed at any temperature selection of the washing machine or automatic dishwasher. Indeed, the temperature may be from the unheated temperature of the feed-water up to about 95° C. Preferably, the method according to the present invention includes using the acidic aqueous liquor at a temperature of from unheated to about 95° C., more preferably from unheated to about 70° C., even more preferably from about 30° C. to about 60° C.

In a preferred embodiment according to the present invention, the particulate composition herein is dissolved or dispersed, preferably substantially dissolved or dispersed, in the aqueous liquor formed in the method according to the present invention. By “substantially dissolved or dispersed” it is meant herein, that at least about 50%, preferably at least about 80%, more preferably at least about 90%, even more preferably at least about 95%, still more preferably at least about 98%, and most preferably at least about 99%, of said particulate composition is dissolved or dispersed in the aqueous liquor formed in the method according to the present invention.

The particulate composition may be delivered into the washing machine or automatic dishwasher either by charging the dispenser drawer of the washing machine or the dispenser compartment of the automatic dishwasher with the particulate composition or by directly charging the drum of the washing machine or the washing compartment of the automatic dishwasher with the particulate composition. The particulate composition may be directly placed into the drum of the washing machine or the washing compartment of the automatic dishwasher, preferably using a dosing device, such as a dosing ball (such as the Vizirette®).

During the method according to the present invention the particulate composition herein is typically dissolved up to about 2000 times its own weight, preferably from about 10 to about 1500 times and more preferably from about 20 to about 1000 times with water.

In the process according to the present invention an acidic aqueous liquor is formed. Said liquor is formed in said washing machine or automatic dishwasher and thus comes into direct contact with the interior surfaces of washing machines or automatic dishwashers. Due to the agitation, spraying and/or pumping of said liquor upon execution of a wash cycle in the washing machine or automatic dishwasher, the interior surfaces of washing machines or automatic dishwashers are contacted with the wash liquor herein.

The acidity of the liquor is contributed by the particulate composition as described herein below. The aqueous liquor maintains an acidic pH over the course of the process of cleaning as described herein. Upon a rinsing of the washing machine or automatic dishwasher, if any, the pH may rise due to the increased dilution of the aqueous liquor with water and the increased dilution of the acidity found therein.

The Particulate Composition

In the method of cleaning the interior surfaces of a non-loaded washing machine or a non-loaded automatic dishwasher herein, a particulate composition comprises an effervescent system and sufficient acid to form an acidic aqueous liquor having a pH of below 4 is used.

By “particulate” it is meant herein powders, pearls, granules, tablets and the like.

In the preferred embodiments wherein the particulate composition is a tablet, then the tablet may be of uniform composition, or alternatively may comprise one or more first regions and one or more second regions (multi-phase tablets or multi-layer tablets). Multi-phase tablets are described in the Applicant's patent application PCT/US99/15492 (incorporated herein by reference).

The particulate composition herein has a pH measured at 25° C., preferably of at least, with increasing preference in the order given, preference in the order given, about 0.1, about 0.5, about 1, about 1.5, about 2, about 2.5, about 3, about 3.5, about 4 when diluted into 500 times its weight of water. Independently, the particulate composition herein has a pH measured at 25° C., preferably of no more than, with increasing preference in the order given, about 12, about 11.5, about 11, about 10.5, about 10, about 9.5, about 9, about 8.5, about 8, about 7.5, about 7, about 6.5, about 6, about 5.5, about 5, about 4.5, about 4, about 3.5, about 3, about 2.5 when diluted into 1 to 500 times its weight of water.

The cleaning performance for limescale deposits of the particulate compositions may be evaluated by the following test method:

The limescale removal capacity of a particulate composition may be evaluated by soaking encrusted ceramic tiles prepared using the auto dish washing machine in an aqueous liquor formed by combining water and the particulate composition. Black glazed ceramic tiles (typically 20 cm×20 cm) are poured into the auto dish washing machine and treated with 7 complete washing cycles. Each cycle is performed using 15 g of Sodium Carbonate (instead of the detergent) at temperature of 80° C. and rinsing water at 70° C. The resulting tiles will have a homogeneous thin layer of limescale (calcium carbonate precipitated during the washing cycle). Then, the encrusted tiles are soaked for 30 min in an aqueous liquor formed by combining 1000 ml of water and 2 grams of particulate composition. Thereafter the tiles are rinsed for 30 seconds with water (until all residues of product are removed) and then left to dry. After the surfaces treated with the composition have dried, they are visually graded to evaluate limescale removal difference. Performance evaluation may be generally done by applying the Panel Score Unit (PSU).

A visual grading may be used to assign difference in panel units (psu) in a range from 0 to 4, wherein 0 means no noticeable limescale removal and 4 means a complete limescale removal.

Acid

The particulate compositions herein comprises sufficient acid to form an acidic aqueous liquor having a pH of below about 4 is used. The acid herein provides excellent limescale removal performance.

Suitable acids herein may be organic or inorganic acids or mixtures thereof. Suitable organic acids herein are selected from the group consisting of: succinic acid, maleic acid, malonic acid, citric acid, glutaric acid, malic acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mixtures thereof. Suitable inorganic acids herein are selected from the group consisting of: Sulphamic acid, solid abducts of phosphoric acid (such as urea phosphate), solid abducts of nitric acid, solid abducts of sulphonic acid, solid abducts of sulphuric acid, solid abducts of hydrogen-sulfuric acid, and solid abducts of dihydrogen-phosphoric acid, and mixtures thereof. Preferably the acid herein is selected from the group consisting of citric acid, sulphamic acid, and maleic acid and mixtures thereof. Most preferably said acid is citric acid.

Liquid acids, such as phosphoric acid, can be mixed with salts of the same or another acid if needed to solidify the acid.

The acid herein is present in a sufficient amount to form an acidic aqueous liquor having a pH of below about 4. By “sufficient amount to form an acidic aqueous liquor having a pH of below about 4” it is meant herein that upon dilution into 500 times the particulate composition's weight of conventional tap water (i.e., 20 grams of particulate composition in 10000 grams (10 lt.) of water) a pH of below 4 measured at 25° C. is provided. The 500 times dilution above is equivalent to the average dilution achieved in a common washing machine or an automatic dishwasher.

In a preferred embodiment the acid herein is present in a sufficient amount to form an acidic aqueous liquor having a pH of below about 3.8, preferably below about 3.5, more preferably from about 0.5 to about 3.5, even more preferably from about 1.0 to about 3.0 and most preferably from about 2.0 to about 3.0.

Due to the difference in pKa and/or strengths of different acids, the level of acid required to provide an acidic aqueous liquor having a pH of below about 4 may vary.

In a preferred embodiment, wherein said acid is citric acid, the particulate compositions herein comprise at least about 50% by weight of the total composition of citric acid. Preferably, the particulate compositions herein comprise at least about 60%, more preferably from about 60% to about 95% and most preferably from about 70% to about 95% by weight of the total composition of citric acid.

In a preferred embodiment, wherein said acid is sulphamic acid, the particulate compositions herein comprise at least about 50% by weight of the total composition of sulphamic acid. Preferably, the particulate compositions herein comprise at least about 60%, more preferably from about 60% to about 95% and most preferably from about 70% to about 95% by weight of the total composition of sulphamic acid.

In a preferred embodiment, wherein said acid is maleic acid, the particulate compositions herein comprise at least about 50% by weight of the total composition of maleic acid. Preferably, the particulate compositions herein comprise at least about 60%, more preferably from about 60% to about 95% and most preferably from about 70% to about 95% by weight of the total composition of maleic acid.

In a preferred embodiment, wherein said acid is a mixture of citric acid and maleic acid, the particulate compositions herein comprise from about 25% to about 70% weight of the total composition of citric acid and from about 70% to 2 about 5% % weight of the total composition of maleic acid.

Suitable citric acid is commercially available from Roche. Suitable maleic acid is commercially available from FLUKA Suitable sulphamic acid is commercially available from Rhodia.

In case the effervescence system as required in the present invention and described herein below contains alkaline material, if any, providing an alkaline pH to the aqueous liquor formed herein, then the level of acid has to be increased accordingly to compensate for this alkalinizing effect. Furthermore, in case the effervescence system as required in the present invention and described herein below contains an acid, then the acid present in the effervescence system can be considered contributing to the acidity of the aqueous liquor formed herein. Indeed, it is not required to add a separate acid (i. e., effectively a second or third acid) if the effervescence system comprises an acid in a sufficient amount to form an acidic aqueous liquor having a pH of below about 4.

Effervescence System

The particulate compositions herein comprise an effervescence system.

Suitable effervescence systems herein are single-component effervescence systems or multi-component effervescence systems.

Single-component effervescence systems are effervescence systems that generate effervescency upon dissolution or dispersion in water of the particulate composition due to a chemical or physical reaction of the single-component with water.

Multi-component effervescence systems are effervescence systems that generate effervescency upon dissolution or dispersion in water of the particulate composition due to a chemical or physical reaction of the components with each other. Suitable multi-component effervescence systems are selected from the group consisting of: mixtures of acids, such as citric acid, or mixtures with another acid, with carbonate (such as Na carbonate) and/or bicarbonate (such as Na bicarbonate).

Preferably, the effervescence system herein is a multi-component effervescence system, more preferably the effervescence system herein comprises citric acid and carbonate (such as Na carbonate) and/or bicarbonate (such as Na bicarbonate).

The components of a multi-component effervescence system may be in the same region of the particulate composition or in distinct regions thereof. Indeed, if the particulate composition is in the form of a multi layer tablet or a molded tablet, then the components of a multi-component effervescence system may present in the same tablet regions or they may be in separate regions. Furthermore, the components of a multi-component effervescence systems may be physically separated from each other (e.g., in distinct particles) or they may be co-compressed to form effervescence particles. Moreover, the components of a multi-component effervescence system may be distributed in a concentration gradient over a single layer or multi layer tablet or there may be an equal distribution over the tablet.

The particulate composition herein may comprise from about 0.1% to about 50%, preferably from about 1% to about 5%, more preferably from about 2% to about 5% by weight of the total composition of said effervescence system.

The Applicant has found that by cleaning the interior surfaces of a non-loaded washing machine or a non-loaded automatic dishwasher with a particulate composition according to the present invention a faster dissolution or dispersion of the particulate composition due to the effervescency provided by the effervescence system and connected thereto a faster action of the acid to remove limescale is provided. Moreover, the effervescency provided by the effervescence system provides a deposit (limescale deposits and/or other deposits) removal performance, by physically loosening the deposits from the surfaces whereon they are deposited.

The combination of the fast acting acidity against limescale deposits and the added limescale deposits and/or other deposits removal performance provided by the effervescency, results in an excellent cleaning performance. This effect is particularly notable, when performing the method herein at low temperature and/or using a short washing cycle, as described in a preferred embodiment herein.

Optional Ingredients

The particulate compositions herein may further comprise a variety of other optional ingredients such as bleaches, surfactants, filers, disintegration agents, chelating agents, radical scavengers, antioxidants, stabilisers, builders, perfumes, pigments, dyes and the like.

Fillers

The particulate compositions of the present invention may comprise a filler salt as a highly preferred though option ingredient.

Suitable filler salts herein are selected from the group consisting of sodium sulfate, sodium chloride, sodium tripolyphosphate “STPP” and the like.

Typically, the compositions according to the present invention may comprise from up to about 75% by weight of the total composition of a filler salt or a mixture thereof, preferably from about 70% to about 10% and more preferably from about 60% to about 30%.

Surfactants

The compositions of the present invention may comprise a surfactant or a mixture thereof including nonionic surfactants, anionic surfactants, cationic surfactants, zwitterionic surfactants and/or amphoteric surfactants.

Preferably, the composition herein additionally comprises a nonionic surfactant, more preferably an alkoxylated nonionic surfactant.

Typically, the compositions according to the present invention may comprise from about 0.01% to about 50% by weight of the total composition of a surfactant or a mixture thereof, preferably from about 0.1% to about 30% and more preferably from about 0.2% to about 10%.

Chelating Agents

The compositions of the present invention may comprise a chelating agent as an optional ingredient.

Suitable phosphonate chelating agents for use herein may include alkali metal ethane 1-hydroxy diphosphonates (HEDP), alkylene poly (alkylene phosphonate), as well as amino phosphonate compounds, including amino aminotri (methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. (incorporated herein by reference). Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins (incorporated herein by reference). Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula: 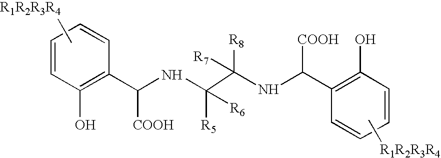
wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein are amino aminotri (methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the compositions according to the present invention comprise up to about 5% by weight of the total composition of a chelating agent, or mixtures thereof, preferably from about 0.01% to about 1.5% by weight and more preferably from about 0.01% to about 0.5%.

Disintegration Agent

The compositions of the present invention may comprise a disintegration agent as an optional ingredient (in addition to the effervescence system). Disintegration agents are highly preferred optional ingredients in the preferred embodiment herein, wherein said particulate composition is a tablet.

Suitable disintegration agents include agents that swell on contact with water or facilitate water influx and/or efflux by forming channels in the detergent tablet.

Suitable disintegration agents are selected from the group consisting of: starches such as: natural, modified or pre-gelatinised starch and sodium starch gluconate; starch derivatives such as cellulose and derivatives thereof; gums: agar gum, guar gum, locust bean gum, karaya gum, pectin gum, tragacenth gum; algenic acid and its salts including sodium alginate; silicone dioxide; soy polysaccharides; polyvinylpyrrolidone; crospovidone; clays; acetate trihydrate; burkeite; monohydrated carbonate formula Na₂CO₃.H₂O; hydrated STPP with a phase I content of at least about 40%; carboxymethylcellulose (CMC); CMC-based polymers; sodium acetate; aluminum oxide; and mixtures thereof.

Preferred disintegration agents herein are selected from the group consisting of: celluloses and derivatives thereof; microcrystalline cellulose; and mixtures thereof.

Suitable cellulose is commercially available under the tradename Arbocel®, commercially available from Rettenmaier and Nymcel® available from Metsa-serla. Suitable microcrystalline cellulose is available under the tradename Vivapur® from Rettenmaier.

The particulate compositions herein may comprise from about 0.5% to about 15%, preferably from about 1% to about 10%, more preferably from about 2% to about 5% by weight of the tablet of a disintegration agent.

Minor Ingredients

The composition described herein may also comprise minor ingredients such as pigment or dyes and perfumes.

Packaging Form of the Particulate Compositions:

Depending on the end-use envisioned, the compositions herein can be packaged in a variety of containers including conventional boxes, tubs etc.

The invention is further illustrated by the following examples.

### EXAMPLES

The following examples will further illustrate the present invention. The compositions are made by combining the listed ingredients in the listed proportions (weight % unless otherwise specified). The following Examples are meant to exemplify compositions according to the present invention but are not necessarily used to limit or otherwise define the scope of the present invention.

Compositions (% weight)
TABLETS

| | I | II | III | IV | V |
|---|---|---|---|---|---|
| Citric acid | 96 | 90 | 94 | 89 | 54 |
| Sodium | 4 | 10 | 4 | 9 | 4 |
| bicarbonate | | | | | |
| Plurafac ® | — | — | 1 | 1 | 1 |
| LF224 | | | | | |
| Neodol ® C11 | — | — | 1 | 1 | 1 |
| EO 8 | | | | | |
| Maleic acid | — | — | — | — | 40 |
| Tablet weight | 20 | 20 | 20 | 20 | 20 |
| [grams] | | | | | |

POWDERS

| | VI | VII | VIII | IX | X |
|---|---|---|---|---|---|
| Citric acid | 96 | 90 | 94 | 89 | 54 |
| Sodium | 4 | 10 | 4 | 9 | 4 |
| bicarbonate | | | | | |
| Plurafac ® | — | — | 1 | 1 | 1 |
| LF224 | | | | | |
| Neodol ® C11 | — | — | 1 | 1 | 1 |
| EO 8 | | | | | |
| Maleic acid | — | — | — | — | 40 |
| Average dosage | 20 | 20 | 20 | 20 | 20 |
| per wash-load | | | | | |
| [grams] | | | | | |

Plurafac ® LF224 is an alkoxylated nonionic surfactant available from BASF.
Neodol ® C11 EO 8 is an ethoxylated nonionic surfactant available from Shell.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of cleaning the interior surfaces of a non-loaded washing machine or a non-loaded automatic dishwasher with a particulate composition by forming in said washing machine or automatic dishwasher an acidic aqueous liquor comprising water and dissolved or dispersed therein said particulate composition, wherein said particulate composition comprises an effervescence system and sufficient acid to form an acidic aqueous liquor having a pH of below 4.

2. A method according to claim 1, wherein said acidic aqueous liquor is used at a temperature of from the temperature of unheated water to about 95° C.

3. A method according to claim 1, wherein said acidic aqueous liquor is used at a temperature of from about 30° C. to about 60° C.

4. A method according to claim 1, wherein said particulate composition is dissolved up to about 2000 times its own weight.

5. A method according to claim 1, wherein said acid is an organic acid or an inorganic acid or a mixture thereof.

6. A method according to claim 1, wherein said acid is an organic acid selected from the group consisting of: succinic acid, maleic acid, malonic acid, citric acid, glutaric acid, malic acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mixtures thereof.

7. A method according to claim 1, wherein said acid is selected from the group consisting of citric acid, sulphamic acid, and maleic acid and mixtures thereof.

8. A method according to claim 1, wherein said acid is citric acid.

9. A method according to any of the preceding claims, wherein said acid is present in a sufficient amount to form an acidic aqueous liquor having a pH of below about 3.8.

10. A method according to claim 1, wherein said effervescence system is a single-component effervescence system or multi-component effervescence system.

11. A method according to claim 1, wherein said effervescence system is a multi-component effervescence system, more preferably comprises citric acid and carbonate and/or bicarbonate.

12. A method according to any of the preceding claims, wherein said particulate composition comprises from about 0.1% to about 50% by weight of the total composition of said effervescence system.
